(19) United States
(12) Patent Application Publication
(10) Pub. No.: US 2022/0294070 A1
(43) Pub. Date: Sep. 15, 2022

(54) BUFFER MEMBER, ELECTRICAL STORAGE MODULE, AND METHOD FOR MANUFACTURING BUFFER MEMBER

(71) Applicant: Panasonic Intellectual Property Management Co., Ltd., Osaka (JP)

(72) Inventors: GORO FUJITA, Osaka (JP); SHOTA NORIMINE, Osaka (JP); TETSUJI OMURA, Hyogo (JP); MITSUTOSHI TAJIMA, Hyogo (JP); SHINGO KUME, Osaka (JP)

(21) Appl. No.: 17/635,021

(22) PCT Filed: Sep. 18, 2020
(86) PCT No.: PCT/JP2020/035648

§ 371 Date: Feb. 14, 2022

(30) Foreign Application Priority Data
Sep. 27, 2019 (JP) 2019-176409

(51) Int. Cl. H01M 50/291; H01M 50/209; H01M 50/242; H01M 50/231; H01M 50/543

(52) U.S. Cl. CPC H01M 50/291; H01M 50/209; H01M 50/242; H01M 50/231; H01M 50/543

(57) ABSTRACT

An electrical storage module includes: at least one electrical storage device; and a buffer member that is arranged in first direction X together with the electrical storage device and is configured to receive a load from the electrical storage device in first direction X. The buffer member includes a first layer portion and a second layer portion arranged in first direction X. The first layer portion has first softened portions each formed of a through hole or a recessed part. The second layer portion has second softened portion each formed of a through hole or a recessed part. The first softened portion and the second softened portion are at least partially displaced from each other as viewed in first direction X.

### TECHNICAL FIELD

The present disclosure relates to a buffer member, an electrical storage module, and a method for manufacturing a buffer member.

### BACKGROUND ART

As a power source that requires a high output voltage such as a power source for a vehicle, for example, there has been known an electrical storage module in which a plurality of electrical storage devices (for example, batteries) are connected in series. In general, an electrical storage module includes: a plurality of electrical storage devices; a plurality of separators arranged between electrical storage devices arranged adjacent to each other; a pair of end plates arrange at both ends in an arrangement direction of the electrical storage devices; and binding bars that extend between the pair of end plates and constrains the plurality of electrical storage devices in the arrangement direction (see, for example, patent literature 1).

### CITATION LIST

### Patent Literature

PTL 1: Unexamined Japanese Patent Publication No. 2015-99648

### SUMMARY OF THE INVENTION

### Technical Problem

In general, the electrical storage device expands due to various factors. In the conventional electrical storage module, this expansion is suppressed by end plates and binding bars. Further, in the electrical storage module, in order to maintain the electrical connection between the electrical storage devices and to prevent the electrical storage devices from popping out due to an impact from the outside or the like, the electrical storage devices are fixed by a constraining force generated by the binding bars.

In recent years, there has been a demand for further increase of a capacity of an electrical storage module. To satisfy this demand, steady efforts to increase capacity of an electrical storage device have been in progress. As the capacity of the electrical storage device is increased, an amount of expansion of the electrical storage device is increased. Accordingly, a load applied to the binding bars is also increased. Therefore, it is necessary to take measures to prevent breaking of the binding bars so as to ensure the reliability of the electrical storage module. By weakening a constraining force of the binding bar, a load applied to the binding bar can be reduced. In this case, breaking of the binding bar can be suppressed. However, when a constraining force of the binding bar is weakened, the positioning of the electrical storage devices may be loosened thus giving rise to a possibility that reliability of the electrical storage module is lowered.

The present disclosure has been made in view of such circumstances, and it is an object of the present disclosure to provide a technique by which the reliability of an electrical storage module can be increased.

### Solution to Problem

One aspect of the present disclosure is to provide an electrical storage module. The electrical storage module includes: at least one electrical storage device; and a buffer member that is arranged together with the electrical storage device in a first direction and is configured to receive a load from the electrical storage device in the first direction. The buffer member has at least a first layer portion and a second layer portion arranged in the first direction. The first layer portion has a first softened portion that is formed of a through hole that penetrates the first layer portion in the first direction or a recessed part that is recessed in the first direction. The second layer portion has a second softened portion that is formed of a through hole that penetrates the second layer portion in the first direction or a recessed part that is recessed in the first direction. The first softened portion and the second softened portion are at least partially displaced from each other as viewed in the first direction.

Another aspect of the present disclosure is a buffer member that is arranged in the first direction together with at least one electrical storage device and receives a load from the electrical storage device in the first direction. The buffer member includes at least a first layer portion and a second layer portion arranged in the first direction. The first layer portion has a first softened portion that is formed of a through hole that penetrates the first layer portion in the first direction or a recessed part that is recessed in the first direction. The second layer portion has a second softened portion that is formed of a through hole that penetrates the second layer portion in the first direction or a recessed part that is recessed in the first direction. The first softened portion and the second softened portion are at least partially displaced from each other as viewed in the first direction.

Another aspect of the present disclosure is a method for manufacturing a buffer member that is arranged in a first direction together with at least one electrical storage device and receives a load from the electrical storage device in the first direction. This manufacturing method includes stacking of: a first sheet having a first softened portion formed of a through hole that penetrates the first sheet in a thickness direction or a recessed part that is recessed in the thickness direction; and a second sheet having a second softened portion formed of a through hole that penetrates the second sheet in the thickness direction or a recessed part that is recessed in the thickness direction in a state where the first softened portion and the second softened portion are at least partially displaced from each other.

Any combinations of the above constituent elements, and modifications of the present disclosure obtained by converting the present disclosure in the form of a method, an apparatus, a system, and the like are also effective as aspects of the present disclosure.

### Advantageous Effect of Invention

According to the present disclosure, the reliability of the electrical storage module can be enhanced.

### BRIEF DESCRIPTION OF THE DRAWINGS

FIG. 1 is a perspective view of an electrical storage module according to an exemplary embodiment.

FIG. 2 is an exploded perspective view of the electrical storage module.

FIG. 3 is a cross-sectional view schematically illustrating how respective electrical storage devices expand.

FIG. 4 is a front view of a buffer member according to a first exemplary embodiment.

FIG. 5(A) is a front view of a first layer portion that a buffer member includes. FIG. 5 (B) is a front view of a second layer portion that the buffer member includes.

FIG. 6(A) to FIG. 6(D) are cross-sectional views of a portion of the buffer member.

FIG. 7(A) is a perspective view of a buffer member according to a first modification. FIG. 7(B) is a front view of the buffer member.

FIG. 8(A) is a perspective view of a buffer member according to a second modification. FIG. 8(B) is a front view of the buffer member.

FIG. 9(A) is a perspective view of a buffer member according to a fifth modification. FIG. 9(B) is a cross-sectional perspective view taken along line A-A in FIG. 9(A).

### DESCRIPTION OF EMBODIMENTS

Hereinafter, the present disclosure will be described on the basis of preferred exemplary embodiments with reference to the drawings. The exemplary embodiments are not intended to limit this disclosure but are illustrative, and all technical features described in the exemplary embodiments and combinations of the technical features are not necessarily essential to this disclosure. The identical or equivalent constituent elements, members, and processing illustrated in the respective drawings are denoted by the same reference numerals, and repetitious description will be omitted when appropriate. The scale and the shape of each portion illustrated in each drawing are set for convenience in order to facilitate the understanding of the description and should not be interpreted in a limited manner unless otherwise specified. In cases where terms such as “first” and “second” are used in the present specification or claims, unless otherwise specified, these terms do not represent any order or importance but are intended to distinguish one configuration from other configurations. In each drawing, some members which are not important for describing the exemplary embodiment are omitted.

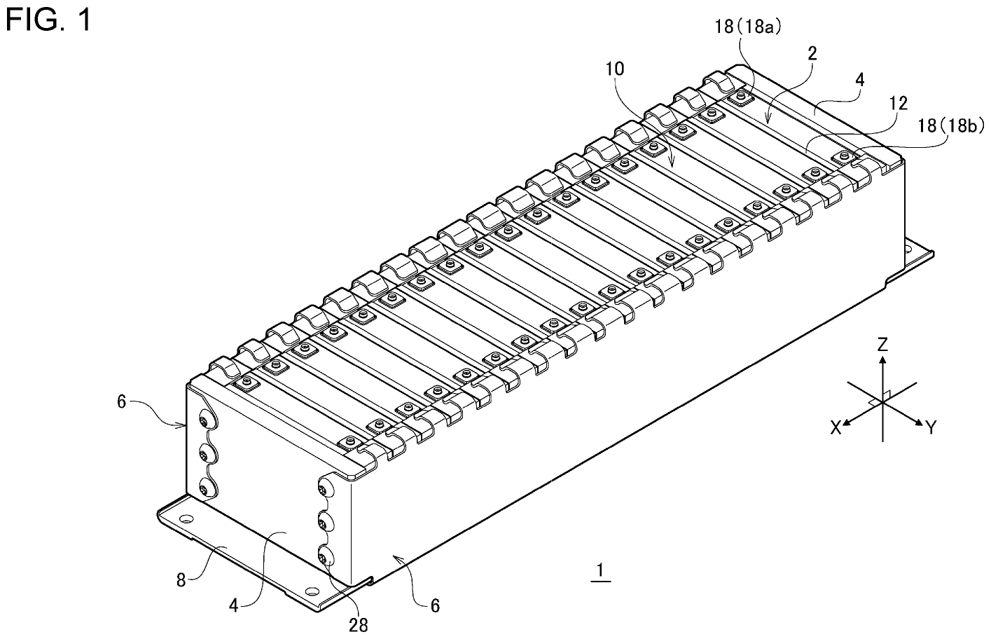

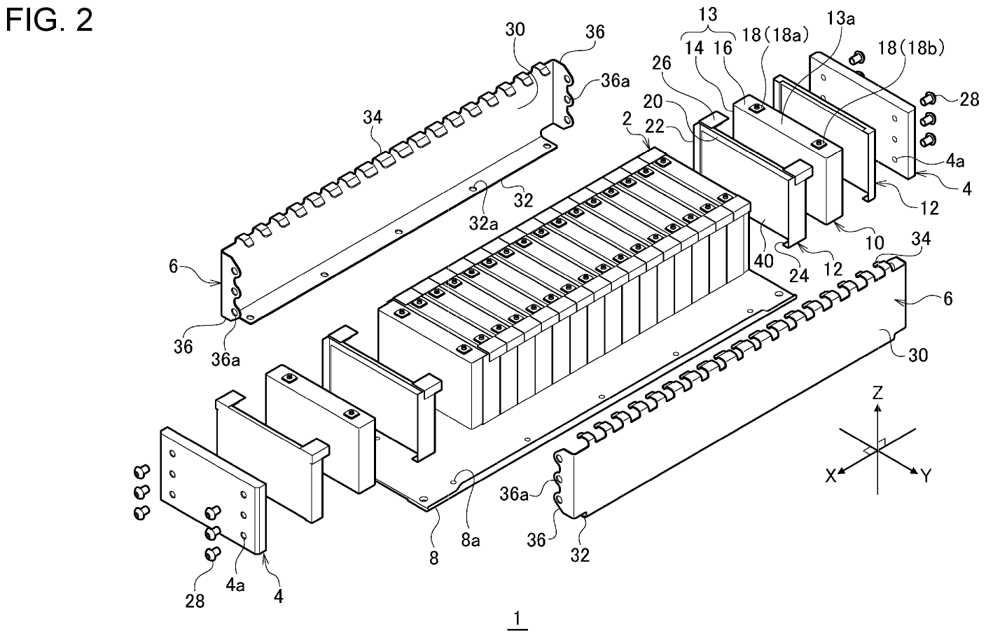

FIG. 1 is a perspective view of an electrical storage module according to an exemplary embodiment. FIG. 2 is an exploded perspective view of the electrical storage module. In FIG. 2, buffer member 40 is illustrated in a simplified manner. Electrical storage module 1 includes, as an example, battery stack 2, a pair of constraining members 6, and cooling plate 8. Battery stack 2 includes a plurality of electrical storage devices 10, a plurality of separators 12, a plurality of buffer members 40, and a pair of end plates 4.

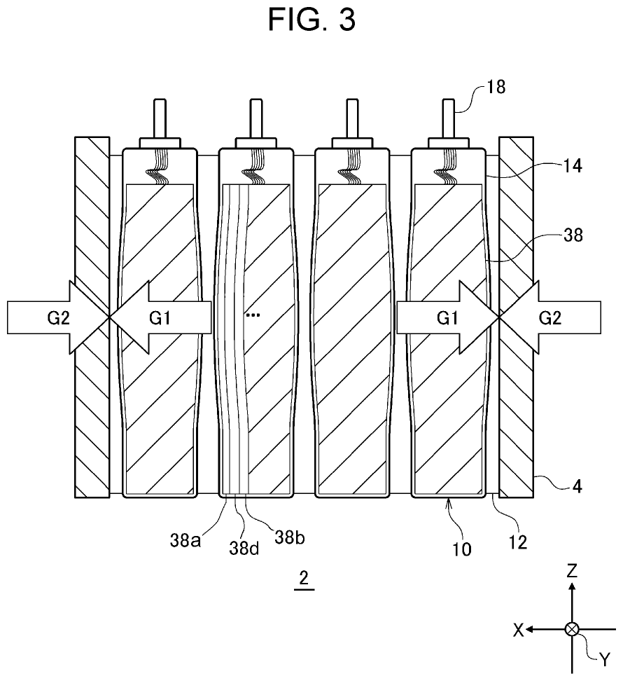

Each electrical storage device 10 is, for example, a chargeable secondary battery such as a lithium ion battery, a nickel-hydrogen battery, or a nickel-cadmium battery, or a capacitor such as an electric double layer capacitor. Electrical storage device 10 according to the exemplary embodiment is a so-called prismatic battery, and has housing 13 having a flat rectangular parallelepiped shape. Housing 13 is formed of outer covering can 14 and sealing plate 16. Exterior can 14 has a substantially rectangular opening. The opening is formed in one surface of outer covering can 14. Electrode assembly 38 (see FIG. 3) that includes positive electrode 38a, negative electrode 38b, and porous separator 38d, and an electrolyte solution, and the like are accommodated in outer covering can 14 through opening. Exterior can 14 is covered with an insulating film such as a shrink tube not illustrated in the drawing. By covering a surface of outer covering can 14 with the insulating film, it is possible to suppress a short circuit between electrical storage devices 10 arranged adjacent to each other, a short circuit between electrical storage device 10 and end plate 4, and a short circuit between electrical storage device 10 and constraining members 6, and a short circuit between electrical storage device 10 and cooling plate 8. Sealing plate 16 is arranged in the opening of outer covering can 14. Sealing plate 16 seals outer covering can 14 by closing the opening. Sealing plate 16 forms first surface 13a of housing 13.

Electrode assembly 38 has a structure where a plurality of sheet-shaped positive electrodes 38a and a plurality of sheet-shaped negative electrodes 38b are alternately stacked with porous separator 38d interposed between positive electrode 38a and negative electrode 38b (see FIG. 3). Positive electrodes 38a and negative electrodes 38b are aligned in first direction X. Therefore, the electrodes positioned at both ends in the stacking direction face the long-side surfaces of housing 13, which will be described later. Electrode assembly 38 may be a flat winding type electrode assembly formed by winding a band-shaped positive electrode and a band-shaped negative electrode with a porous separator interposed between the positive electrode and the negative electrode. Such electrode assembly 38 has: flat portions where the positive electrode and the negative electrode extend flat; and bent portions where the positive electrode and the negative electrode are bent. In this case, electrode assembly 38 is arranged so that the flat portions extend in the direction that intersects with (for example, is orthogonal to) first direction X. That is, electrode assembly 38 is arranged so that the thickness direction of the flat portions is parallel to first direction X.

Output terminal 18 that is electrically connected to positive electrode 38a of electrode assembly 38 is mounted on sealing plate 16, that is, on first surface 13a of housing 13 near one end of sealing plate 16 in the longitudinal direction, and output terminal 18 that is electrically connected to negative electrode 38b of electrode assembly 38 is mounted on sealing plate 16 near the other end of sealing plate 16 in the longitudinal direction. Hereinafter, output terminal 18 connected to positive electrode 38a is referred to as positive electrode terminal 18a, and output terminal 18 connected to negative electrode 38b is referred to as negative electrode terminal 18b when appropriate. When it is unnecessary to distinguish the polarities of a pair of output terminals 18 from each other, positive electrode terminal 18a and negative electrode terminal 18b are collectively referred to as output terminals 18. Exterior can 14 and sealing plate 16 are conductors, and are made of metal such as aluminum, iron, or stainless steel, for example. Sealing plate 16 and outer covering can 14 are joined to each other by, for example, a laser, friction stir welding, brazing or the like. Alternatively, outer covering can 14 and sealing plate 16 are made of a resin having insulating property.

Exterior can 14 has a bottom surface that faces sealing plate 16. Exterior can 14 also has four side surfaces that connect the opening and the bottom surface of outer covering can 14. Out of four side surfaces of outer covering can 14, two side surfaces are a pair of long-side surfaces, which are connected to two long sides of the opening and the bottom which face each other. Each long side surface is a surface having the largest area among the surfaces of outer covering can 14, that is, a main surface. Each long side surface is also a side surface extending in a direction that intersects with (for example, is orthogonal to) first direction X. Remaining two side surfaces after excluding two long-side surfaces from four side surfaces of outer covering can 14 are a pair of short-side surfaces that are connected to two short sides of the opening and the bottom surface of outer covering can 14 that face each other. The bottom surface, the long-side surfaces, and the short-side surfaces of outer covering can 14 correspond to the bottom surface, the long-side surfaces, and the short-side surfaces of housing 13, respectively.

In the description of the present exemplary embodiment, for the sake of convenience, first surface 13a of housing 13 is assumed as an upper surface of electrical storage device 10. The bottom surface of housing 13 is assumed as the bottom surface of electrical storage device 10, the long-side surfaces of housing 13 are assumed as the long-side surfaces of electrical storage device 10, and the short-side surfaces of housing 13 are assumed as the short-side surfaces of electrical storage device 10. In electrical storage module 1, a surface of electrical storage device 10 on an upper surface side is assumed as an upper surface of electrical storage module 1, a surface of electrical storage device 10 on a bottom surface side is assumed as a bottom surface of electrical storage module 1, and a surface of electrical storage device 10 on a short side surface side is assumed as a side surface of electrical storage module 1. The upper surface side of electrical storage module 1 is defined as an upper side in a vertical direction, and the bottom surface side of electrical storage module 1 is defined as a lower side in the vertical direction. These directions and positions are defined for the sake of convenience. Therefore, for example, a portion defined as the upper surface in the present disclosure does not mean that the portion is always positioned above a portion defined as the bottom surface. Therefore, sealing plate 16 is not always positioned above the bottom surface of outer covering can 14.

A safety valve (not illustrated in the drawings) is mounted on sealing plate 16 at a position between the pair of output terminals 18. The safety valve is configured such that when an internal pressure of housing 13 rises to a predetermined value or more, the safety valve is opened so as to release a gas in housing 13. For example, the safety valve is formed of: a thin wall portion arranged at a portion of sealing plate 16 and having a thickness smaller than a thickness of other portions; and a linear groove formed on a surface of the thin wall portion. In this configuration, when an internal pressure in housing 13 rises, the thin-wall portion is torn using the groove as an initiation point so that the safety valve is opened.

The plurality of electrical storage devices 10 are arranged side by side at a predetermined interval such that the long-side surfaces of electrical storage devices 10 arranged adjacent to each other face each other. In the present exemplary embodiment, a direction in which the plurality of electrical storage devices 10 are arranged is defined as first direction X. Output terminals 18 of each electrical storage device 10 are arranged so as to be directed in the same direction. In this exemplary embodiment, for the sake of convenience, output terminals 18 of each electrical storage device 10 are arranged so as to be directed upward in the vertical direction. Alternatively, output terminals 18 of each electrical storage device 10 may be arranged so as to be directed in different directions from each other.

Two electrical storage devices 10 arranged adjacent to each other are arranged (stacked) in such a manner that positive electrode terminal 18a of one electrical storage device 10 and negative electrode terminal 18b of the other electrical storage device 10 are arranged adjacent to each other. Positive electrode terminal 18a and negative electrode terminal 18b are connected in series via a bus bar (not illustrated in the drawings). Alternatively, output terminals 18 of the same polarity in the plurality of electrical storage devices 10 arranged adjacent to each other may be connected in parallel by bus bars to form an electrical storage device block, and the electrical storage device blocks may be connected together in series.

Separator 12 is also referred to as an insulating spacer, and is arranged between two electrical storage devices 10 arranged adjacent to each other. Separator 12 provides electrical insulation between two electrical storage devices 10 arranged adjacent to each other. Separator 12 is made of a resin having insulating property, for example. As an example of a resin that is used for forming separator 12, a thermoplastic resin such as polypropylene (PP), polybutylene terephthalate (PBT), polycarbonate (PC), and a Noryl (registered trademark) resin (modified-PPE) are named. The plurality of electrical storage devices 10 and the plurality of separators 12 are stacked alternately. Separator 12 is also arranged between electrical storage device 10 and end plate 4.

Separator 12 has flat surface portion 20 and wall portions 22. Flat surface portion 20 is interposed between the long-side surfaces of two electrical storage devices 10 arranged adjacent to each other and facing each other. With such a configuration, outer covering cans 14 of electrical storage devices 10 arranged adjacent to each other are more reliably insulated from each other.

Wall portions 22 extend from outer edge portions of flat surface portion 20 in first direction X along which electrical storage devices 10 are arranged, and cover a portion of the upper surface, side surfaces, and a portion of the bottom surface of electrical storage device 10. With such a configuration, a creepage distance between electrical storage devices 10 arranged adjacent to each other, and a creepage distance between electrical storage device 10 and corresponding end plate 4 can be ensured. Further, with such a configuration, housing 13 of electrical storage device 10 and constraining member 6 are more reliably insulated from each other. Further, the position of electrical storage device 10 in second direction Y where output terminals 18 are arranged and the position of electrical storage device 10 in third direction Z where the upper surface and the bottom surface of electrical storage device 10 are arranged can be restricted or fixed. First direction X, second direction Y, and third direction Z are directions orthogonal to each other.

Wall portion 22 includes cutout 24 so as to expose the bottom surface of electrical storage device 10. By forming cutout 24, it is possible to avoid the occurrence of a state where thermal connection between electrical storage device 10 and cooling plate 8 is interrupted by separator 12. Further, separator 12 has biasing receiving portions 26 directed upward at both end portions of separator 12 in second direction Y.

Buffer members 40 are arranged in first direction X together with the plurality of electrical storage devices 10. Buffer member 40 has a sheet shape, and is interposed between the long side surface of each electrical storage device 10 and flat surface portion 20 of each separator 12, for example. The number of buffer members 40 arranged between two electrical storage devices 10 arranged adjacent to each other may be one or a plural. Buffer member 40 can be fixed to a surface of flat surface portion 20 by adhesion or the like. Alternatively, a recessed part may be formed in flat surface portion 20, and buffer member 40 may be fitted into the recessed part. The structure and the manner of operation of buffer member 40 will be described in detail later.

The plurality of electrical storage devices 10, the plurality of separators 12, and plurality of buffer members 40 arranged side by side are sandwiched by the pair of end plates 4 in first direction X. Separators 12 are arranged between the pair of end plates 4 and the electrical storage devices 10 arranged at both ends in first direction X. With such a configuration, outer covering can 14 of electrical storage device 10 and end plate 4 are more reliably insulated from each other. End plate 4 is formed of a metal plate or a resin plate, for example. Threaded holes 4a are formed in end plate 4 in a penetrating manner in first direction X, and screws 28 threadedly engage with threaded holes 4a.

The pair of constraining members 6 is also referred to as binding bars. Constraining members 6 are elongated members, and a longitudinal direction of constraining member 6 is defined as first direction X. The pair of constraining members 6 is arranged so as to face each other in second direction Y. Battery stack 2 is interposed between the pair of constraining members 6. Each constraining member 6 includes: body portion 30; support portion 32; a plurality of biasing portions 34; and a pair of fixing portions 36.

Body portion 30 is a rectangular portion that extends in first direction X. Body portion 30 extends in parallel to the side surfaces of respective electrical storage devices 10. Support portion 32 extends in first direction X and protrudes from a lower end of body portion 30 in second direction Y. Support portion 32 is a plate-shaped body that is continuously formed in first direction X, and supports battery stack 2.

The plurality of biasing portions 34 are connected to an upper end of body portion 30 and protrude in second direction Y. Support portion 32 and respective biasing portions 34 face each other in third direction Z. Also, the plurality of biasing portions 34 are arranged in first direction X with a predetermined interval. Respective biasing portions 34 are arranged corresponding to respective electrical storage devices 10. Respective biasing portions 34 have a leaf spring shape, and bias respective electrical storage devices 10 toward support portion 32.

The pair of fixing portions 36 are plate-shaped bodies protruding in second direction Y from both end portions of body portion 30 in first direction X. The pair of fixing portions 36 face each other in first direction X. Through holes 36a through which screws 28 are inserted are formed in each fixing portion 36. Constraining members 6 are fixed to battery stack 2 by the pair of fixing portions 36.

Cooling plate 8 is a mechanism for cooling the plurality of electrical storage devices 10. Cooling plate 8 is made of a material having heat transfer property such as a metal. Battery stack 2 is placed on a main surface of cooling plate 8 in a state where battery stack 2 is constrained by the pair of constraining members 6. Battery stack 2 is fixed to cooling plate 8 by inserting fastening members (not illustrated in the drawings) such as screws into through holes 32a formed in support portions 32 and through holes 8a formed in cooling plate 8. Each electrical storage device 10 is cooled by a heat exchange between electrical storage device 10 and cooling plate 8. A refrigerant pipe (not illustrated in the drawings) through which a refrigerant flows may be formed in cooling plate 8.

Electrical storage module 1 is assembled by the following method, for example. That is, battery stack 2 is formed by arranging electrical storage devices 10, buffer members 40 and separators 12 in this order repeatedly and by sandwiching electrical storage devices 10, buffer members 40 and separators 12 between the pair of end plates 4 in first direction X. Battery stack 2 is sandwiched between the pair of constraining members 6 in second direction Y. Each constraining member 6 is aligned such that through holes 36a formed in constraining member 6 overlap with threaded holes 4a formed in end plate 4. In this state, screws 28 are inserted into through holes 36a and threadedly engage with threaded holes 4a. In this manner, the plurality of electrical storage devices 10 are constrained by making the pair of constraining members 6 engage with the pair of end plates 4. Battery stack 2 is fastened by constraining members 6 in a state where a predetermined pressure is applied to battery stack 2 in first direction X.

The respective electrical storage devices 10 are positioned in first direction X by being fastened in first direction X by constraining members 6. The bottom surfaces of respective electrical storage devices 10 are supported by support portions 32. Wall portion 22 of separator 12 is interposed between the bottom surface of each electrical storage device 10 and support portions 32. Further, biasing portion 34 comes into contact with biasing receiving portion 26 that corresponds to each electrical storage device 10. Each biasing portion 34 biases each electrical storage device 10 toward support portions 32 by way of biasing receiving portions 26. That is, respective electrical storage devices 10 are sandwiched in third direction Z by support portions 32 and the plurality of biasing portions 34. As a result, respective electrical storage devices 10 are positioned in third direction Z.

As an example, after these positioning operations have been completed, the bus bars are attached to output terminals 18 of respective electrical storage devices 10 so that output terminals 18 of the plurality of electrical storage devices 10 are electrically connected to each other. For example, the bus bars are fixed to output terminals 18 by welding. Then, an upper surface of battery stack 2 is covered by a cover member (not illustrated in the drawings). The cover member prevents condensed water, dust, and the like from being brought into contact with output terminals 18, the bus bars, the safety valve, and the like of electrical storage devices 10. The cover member is made of a resin having insulating property, for example. The cover member can be fixed to the upper surface of battery stack 2 by a well-known fixing structure (not illustrated in the drawings) that includes screws and a well-known locking mechanism.

Battery stack 2 on which constraining members 6 and cover member are mounted is placed on cooling plate 8, and battery stack 2 is fixed to cooling plate 8 by inserting the fastening members into through holes 8a and through holes 32a. Electrical storage module 1 is obtained in accordance with the above-mentioned steps. Electrical storage module 1 may be manufactured by mounting battery stack 2 on cooling plate 8 and, thereafter, by fixing battery stack 2 and cooling plate 8 to each other in a collective manner using constraining members 6. In this case, cooling plate 8 is arranged at the inner side of the pair of constraining members 6.

FIG. 3 is a cross-sectional view schematically illustrating how respective electrical storage devices 10 expand. In FIG. 3, the number of electrical storage devices 10 is set smaller than the actual number of electrical storage devices 10. The illustration of the internal structure of electrical storage device 10 and separator 12 is simplified, and buffer members 40 are omitted. As illustrated in FIG. 3, electrode assembly 38 is housed in each electrical storage device 10. In electrical storage device 10, outer covering can 14 repeats expansion and contraction along with charging and discharging of the battery. Expansion of outer covering can 14 is mainly caused due to expansion of electrode assemblies 38. When outer covering cans 14 of respective electrical storage devices 10 expand, load G1 that is directed toward the outside in first direction X is generated in battery stack 2. On the other hand, load G2 that corresponds to load G1 is applied to battery stack 2 by constraining members 6. As a result, expansion of respective electrical storage devices 10 is suppressed.

In the structure where the plurality of electrical storage devices 10 are constrained by constraining members 6, a load is applied to constraining members 6 when the electrical storage devices 10 expand. When an amount of expansion of electrical storage device 10 increases due to the increase in capacity of electrical storage device 10, the load applied to constraining member 6 also increases. When the load applied to the constraining member 6 becomes excessively large, there is a possibility that constraining member 6 is broken. To prevent breaking of constraining member 6, the increase of a strength of constraining member 6 may be considered. However, the increase of the strength of constraining member 6 leads to the increase in size and cost of constraining member 6 and, eventually, the increase in size and cost of electrical storage module 1. Further, in a case where expansion of electrical storage devices 10 is suppressed by constraining members 6, electrode assembly 38 (particularly, porous separator 38d) is excessively pressed. As a result, there is a possibility that the performance of electrical storage device 10 is lowered or the life of electrical storage device 10 becomes short.

By alleviating the constraint of electrical storage device 10 caused by constraining members 6, a load applied to constraining member 6 can be reduced. However, in order to ensure alignment of respective electrical storage devices 10 within electrical storage module 1, it is necessary to apply a certain amount of load to respective electrical storage devices 10. Therefore, the alleviation of the constraint of electrical storage device 10 cannot be simply adopted.

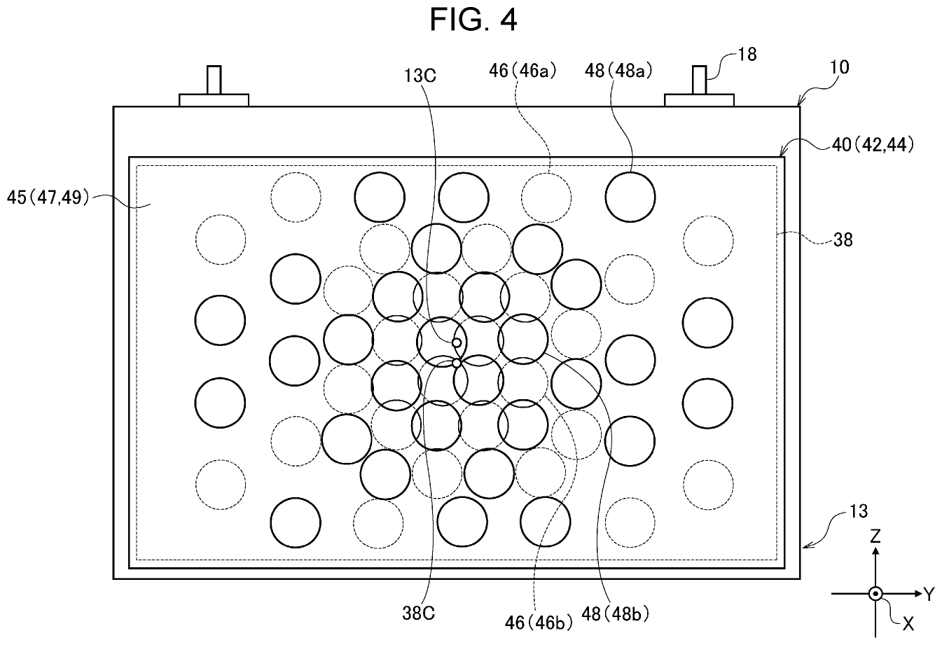

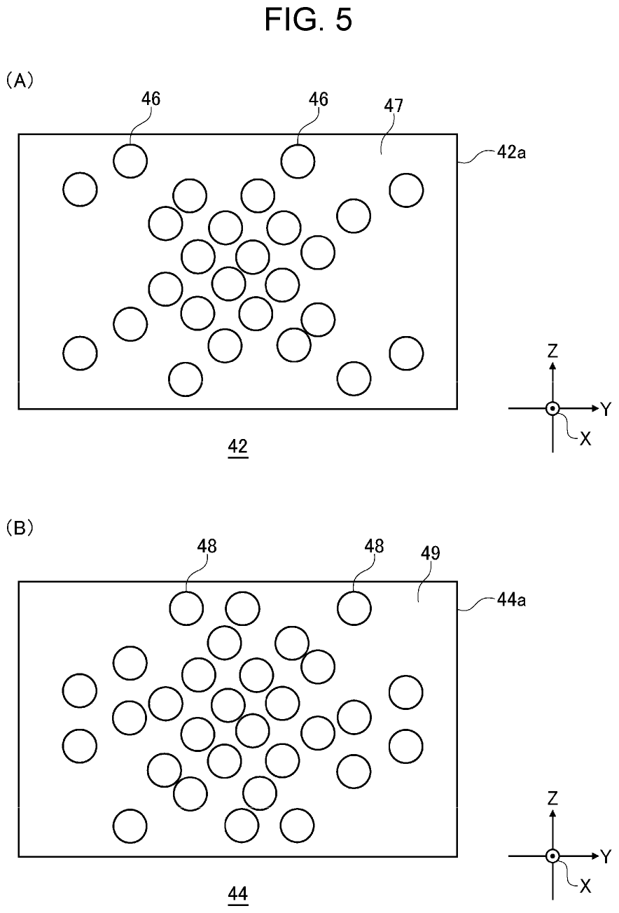

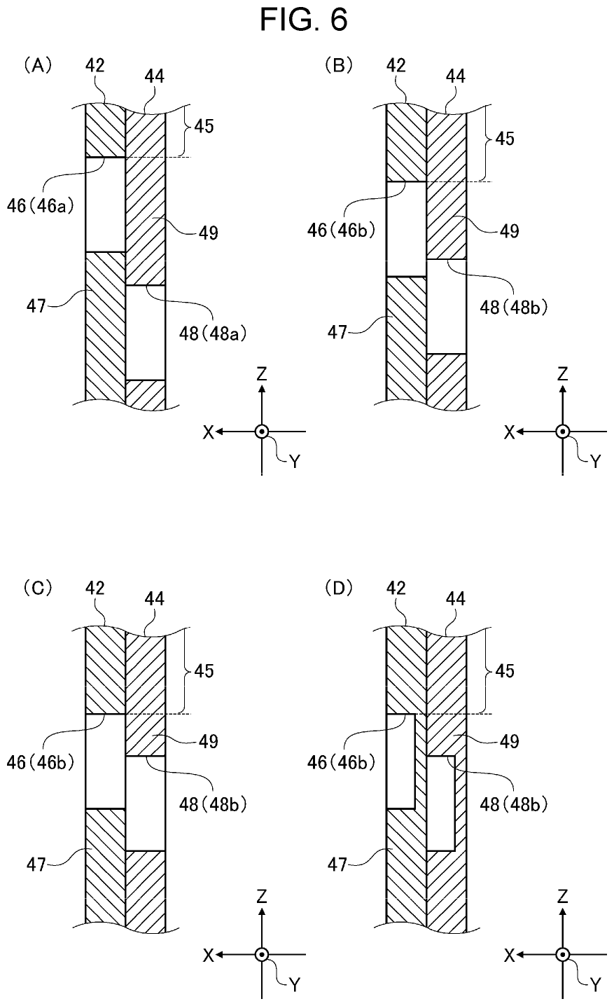

On the other hand, electrical storage module 1 according to the present exemplary embodiment includes buffer members 40. FIG. 4 is a front view of buffer member 40 according to the first exemplary embodiment. FIG. 5(A) is a front view of a first layer portion that buffer member 40 includes. FIG. 5(B) is a front view of a second layer portion that buffer member 40 includes. FIG. 6(A) to FIG. 6(D) are cross-sectional views of portions of buffer member 40. FIG. 4 illustrates buffer member 40 in a state where buffer member 40 is arranged in first direction X together with electrical storage device 10. The illustration of separator 12 is omitted. FIG. 4 illustrates the state where first layer portion 42 is arranged at the depths of FIG. 4 on which FIG. 4 is illustrated, and second layer portion 44 is arranged at the frontal depth of FIG. 4.

Buffer member 40 is a member that is arranged in first direction X together with electrical storage device 10 and receives a load from electrical storage device 10 in first direction X. Buffer member 40 has a sheet shape extending in second direction Y and in third direction Z. Buffer member 40 has at least first layer portion 42 and second layer portion 44 that are arranged in first direction X. Buffer member 40 of the present exemplary embodiment is formed of only first layer portion 42 and second layer portion 44. However, the number of layers of buffer member 40 is not limited to two, and may be three or more. Further, buffer member 40 may include a layer portion that is formed using the same material as first layer portion 42 and second layer portion 44 and has neither through holes nor recessed parts. Both first layer portion 42 and second layer portion 44 have a sheet shape. First layer portion 42 is formed of first sheet 42a, and second layer portion 44 is formed of second sheet 44a.

First layer portion 42 has a plurality of first softened portions 46 and first remaining part 47. In the same manner, second layer portion 44 has a plurality of second softened portions 48 and second remaining part 49. The number of first softened portions 46 and the number of second softened portions 48 may each be one. As illustrated in FIG. 6(A) to FIG. 6(C), first softened portion 46 of the present exemplary embodiment is formed of a through hole penetrating first sheet 42a in first direction X. In the same manner, second softened portion 48 of the present exemplary embodiment is formed of a through hole penetrating second sheet 44a in first direction X. As illustrated in FIG. 6(D), first softened portion 46 and second softened portion 48 may each be formed of a recessed part recessed in first direction X, or a combination of a through hole and a recessed part. It can also be said that the softened portion is a thin wall portion because of its shape. First remaining part 47 is a solid portion excluding the plurality of first softened portions 46. Second remaining part 49 is a solid portion excluding the plurality of second softened portions 48.

As illustrated in FIG. 4 to FIG. 5(B), each first softened portion 46 and each second softened portion 48 has a circular shape as viewed in first direction X. Further, the sizes of first softened portions 46 are uniform, and the sizes of second softened portions 48 are uniform. The shapes and sizes of first softened portion 46 and second softened portion 48 may be different depending on places. For example, first softened portion 46 and second softened portion 48 may each be a groove or a slit hole having a straight line shape.

In first layer portion 42, portions where first softened portions 46 are arranged are more easily deformed than a portion where first softened portions 46 are not arranged, that is, first remaining part 47. In the same manner, in second layer portion 44, portions where second softened portions 48 are arranged are more easily deformed than a portion where second softened portions 48 are not arranged, that is, second remaining part 49. In this exemplary embodiment, the deformation is the compressive deformation in first direction X. A portion of each layer portion that is arranged adjacent to the softened portion and is brought into contact with electrical storage device 10 can be partially displaced toward a softened portion when the layer portion is compressed by receiving a force from electrical storage device 10. That is, a part of the portion arranged adjacent to the softened portion can escape into the softened portion. Therefore, by forming first softened portions 46 and second softened portions 48, it is possible to make a peripheral portion around each softened portion is more easily deformed. In other words, even in a case where the entirety of each layer portion is made of the same material, an apparent elastic modulus (compressive elastic modulus) of a peripheral region around each softened portion can be reduced.

The density of first layer portion 42 is smaller on a center part side than on an outer edge part side of first layer portion 42 as viewed in first direction X. In other words, a ratio of an area of first softened portions 46 to a unit area of first layer portion 42 is larger on the center part side than on the outer edge part side of first layer portion 42 as viewed in first direction X. In the same manner, the density of second layer portion 44 is smaller on a center part side than on an outer edge part side of second layer portion 44 as viewed in first direction X. In other words, a ratio of an area of second softened portions 48 to a unit area of second layer portion 44 is larger on the center part side than on the outer edge part side of second layer portion 44 as viewed in first direction X. In the present specification, with respect to the terms “outer edge part side” and the term “center part side”, when two portions of the target member are compared, the portion arranged close to the center portion of the target member is defined as the “center side”, and the portion arranged away from the center portion of the target member is defined as the “outer edge part side”. The center portion of the target member is, for example, the geometric center of an outer diameter of the target member as viewed in first direction X.

That is, the closer first softened portions 46 to the center portion of first layer portion 42, the larger the number of first softened portions 48 becomes, and the closer second softened portions 48 to the center portion of second layer portion 44, the larger the number of second softened portions 48 becomes. Therefore, with respect to first layer portion 42 and second layer portion 44, the center part side is more easily deformed and the outer edge part side is less easily deformed. The center portion of buffer member 40 is, for example, the geometric center of an outer diameter of buffer member 40 as viewed in first direction X. The outer edge portion of buffer member 40 is, for example, a region of buffer member 40 that includes an end portion of buffer member 40 in second direction Y and an end portion of buffer member 40 in third direction Z.

As described above, expansion of electrical storage device 10 is mainly caused by expansion of electrode assembly 38. Further, the closer a portion of electrode assembly 38 to center portion 38C, the larger expansion of the portion becomes. Therefore, when electrical storage device 10 expands, the closer a portion to center part 13C of the long side surface of housing 13 or closer the portion to center portion 38C of electrode assembly 38, the larger the deformation of the portion in first direction X becomes. On the other hand, the closer a portion to an outer edge portion of housing 13 on long-side surfaces or the closer a portion to an outer edge portion of electrode assembly 38, the smaller the deformation of the portion in first direction X becomes. On the other hand, in buffer member 40, the outer edge part side is relatively less easily deformed, and the center part side is relatively easily deformed. Therefore, buffer member 40 can be easily arranged with respect to electrical storage device 10 such that buffer member 40 receives a large load generated by the large displacement of electrical storage device 10 by the portion of buffer member 40 which is more easily deformed, and receives a small load generated by the small displacement of electrical storage device 10 by the portion of buffer member 40 which is less easily deformed.

Buffer member 40 is obtained by stacking first layer portion 42 and second layer portion 44 in first direction X. First layer portion 42 and second layer portion 44 are made to overlap with each other such that an outer edge portion of first layer portion 42 and an outer edge portion of second layer portion 44 are aligned with each other as viewed in first direction X. Buffer member 40 that is formed by stacking first layer portion 42 and second layer portion 44 to each other has: a portion where at least one of first softened portions 46 and second softened portions 48 are arranged; and a portion where neither first softened portions 46 nor second softened portions 48 is arranged, that is, stacked part 45 where first remaining part 47 and second remaining part 49 overlap with each other.

As a method for positioning first layer portion 42 and second layer portion 44, first softened portion 46 and second softened portion 48 that overlap with each other are arranged near the outer edge portion of first layer portion 42 and near the outer edge portion of second layer portion 44 respectively, and a convex portion or another member for positioning formed on separator 12 are made to engage with first layer portion 42 and second layer portion 44 by fitting engagement thus positioning first layer portion 42 and second layer portion 44. Further, first layer portion 42 and second layer portion 44 may be fixed to each other only by fastening first layer portion 42 and second layer portion 44 in first direction X by constraining member 6, or first layer portion 42 and second layer portion 44 may be fixed to each other by a known fixing method such as adhesion.

In this state, first softened portions 46 and second softened portions 48 are arranged on first layer portion 42 and second layer portion 44 in a state where first softened portions 46 and second softened portions 48 are at least partially displaced from each other as viewed in first direction X. The expression “at least partially displaced from each other as viewed in first direction X” means that at least a portion of an opening edge of one softened portion does not overlap with an opening edge of the other softened portion as viewed in first direction X. Therefore, the expression “at least partially displaced from each other as viewed in first direction X” also includes a case where the entire circumference of the opening edge of one softened portion is positioned at inner or outer side of the opening edge of the other softened portion as viewed in first direction X.

For example, as illustrated in FIG. 6(A), some of first softened portions 46 are arranged such that these first softened portions 46 are totally displaced from second softened portions 48 as viewed in first direction X. Further, as illustrated in FIG. 6(B) and FIG. 6(C), some of other first softened portions 46 are displaced such that the other first softened portions 46 are partially displaced from second softened portions 48 as viewed in first direction X. In the same manner, as illustrated in FIG. 6(A), some of second softened portions 48 are arranged so as to be totally displaced from first softened portions 46 as viewed in first direction X. Further, as illustrated in FIG. 6(B) and FIG. 6(C), some of other second softened portions 48 are arranged so as to be partially displaced from first softened portions 46 as viewed in first direction X.

Hereinafter, for the sake of convenience, first softened portion 46 that is totally displaced from second softened portion 48 as viewed in first direction X is referred to as first spaced-apart portion 46a, and first softened portion 46 that is partially displaced from second softened portion 48 as viewed in first direction X is referred to as first overlapping portion 46b. First layer portion 42 of the present exemplary embodiment has: a plurality of first spaced-apart portions 46a; and a plurality of first overlapping portions 46b. Further, second softened portion 48 that is totally displaced from first softened portion 46 as viewed in first direction X is referred to as second spaced-apart portion 48a, and second softened portion 48 that is partially displaced from first softened portion 46 as viewed in first direction X is referred to as second overlapping portion 48b. Second layer portion 44 of the present exemplary embodiment has: a plurality of second spaced-apart portions 48a; and a plurality of second overlapping portions 48b.

That is, first spaced-apart portion 46a overlaps with none of second softened portions 48 as viewed in first direction X, and the opening of first spaced-apart portion 46a closer to the second layer portion is closed by second remaining part 49. First overlapping portion 46b partially overlaps with any of second softened portions 48 as viewed in first direction X. In the same manner, second spaced-apart portion 48a overlaps with none of first softened portions 46 as viewed in first direction X, and the opening of second spaced-apart portion 48a closer to first layer portion is closed by first remaining part 47. Second overlapping portion 48b partially overlaps with any of first softened portions 46 as viewed in first direction X.

First overlapping portion 46b and second overlapping portion 48b include: a configuration illustrated in FIG. 6(B) where first overlapping portion 46b and second overlapping portion 48b have a relatively large amount of displacement, that is, a portion where first overlapping portion 46b and second overlapping portion 48b overlap with each other is small; and a configuration illustrated in FIG. 6(C) where first overlapping portion 46b and second overlapping portion 48b have a relatively small amount of displacement, that is, the portion where first overlapping portion 46b and second overlapping portion 48b overlap with each other is large. It is to be noted that the entirety of first softened portion 46 overlapping with second softened portion 48 may be provided or the entirety of second softened portion 48 overlapping with first softened portion 46 may be provided.

In buffer member 40, the portion where at least one of first softened portion 46 and second softened portion 48 is arranged is more easily deformed than stacked part 45. Further, the larger the overlapping between first overlapping portion 46b and second overlapping portion 48b, the more easily buffer portion 40 is deformed. That is, by forming the softened portion, it is possible to easily displace a portion arranged adjacent to the softened portion. The larger a portion where first overlapping portion 46b and second overlapping portion 48b overlap with each other, the larger an amount of a portion arranged_adjacent to the softened portion included in a unit area becomes. In other words, the larger the portion where first overlapping portion 46b and second overlapping portion 48b overlap with each other, the smaller an area of stacked part 45 positioned around first overlapping portion 46b and second overlapping portion 48b becomes. Since stacked part 45 is solid, stacked part 45 is less easily deformed compared to the portions where first softened portions 46 and second softened portions 48 are arranged in buffer member 40. Therefore, the larger the overlapping between first softened portion 46 and second softened portion 48, the more easily buffer member 40 is deformed at the portion.

Therefore, compared with the region where first spaced-apart portion 46a or second spaced-apart portion 48a is arranged in buffer member 40 as illustrated in FIG. 6(A), the region where first overlapping portion 46b or second overlapping portion 48b is arranged as illustrated in FIG. 6(B) and FIG. 6(C) is more easily deformed.

Therefore, by forming first spaced-apart portions 46a, second spaced-apart portions 48a, first overlapping portions 46b, and second overlapping portions 48b on buffer member 40, the ease in deformability of buffer member 40 can be finely adjusted depending on the place. In other words, by arranging first spaced-apart portions 46a, second spaced-apart portions 48a, first overlapping portions 46b, and second overlapping portions 48b, the shapes, sizes, positions and quantities of stacked parts 45 arranged around these softened portions can be easily adjusted.

Further, in the present exemplary embodiment, at least one of the plurality of first overlapping portions 46b is arranged closer to the center part side of buffer member 40 than the plurality of first spaced-apart portions 46a as viewed in first direction X. In the same manner, at least one of the plurality of second overlapping portions 48b is arranged closer to the center part side of buffer member 40 than the plurality of second spaced-apart portions 48a as viewed in first direction X. As a result, the center part side of buffer member 40 can be more easily deformed than the outer edge part side of buffer member 40.

Further, in the present exemplary embodiment, at least one of the plurality of first overlapping portions 46b is arranged closer to center part 13C side of the long side surface of housing 13 than the plurality of first spaced-apart portions 46a as viewed in first direction X. With such a configuration, the portion of buffer member 40 that overlaps with the center part 13C side of housing 13 can be more easily deformed than the portion of buffer member 40 that overlaps with an outer edge part side of housing 13. Center portion 13C of the long side surface of housing 13 is, for example, the geometric center of an outer shape of housing 13 as viewed in first direction X. The outer edge portion of the long side surface of housing 13 is, for example, a region that includes an end portion of the long side surface in second direction Y and end portions of the long side surface in third direction Z.

In the same manner, at least one of the plurality of second overlapping portions 48b is arranged closer to the center part 13C side of the long side surface of housing 13 than the plurality of second spaced-apart portions 48a as viewed in first direction X. As a result, the portion of buffer member 40 that overlaps with the center part 13C side of the long side surface of housing 13 can be more easily deformed than the portion of buffer member 40 that overlaps with the outer edge part side of the long side surface of housing 13.

Further, in the present exemplary embodiment, at least one of the plurality of first overlapping portions 46b is arranged closer to the center portion 38C side of electrode assembly 38 than the plurality of first spaced-apart portions 46a as viewed in first direction X. As a result, the portion of the buffer member 40 that overlaps with the center portion 38C side of electrode assembly 38 can be more easily deformed than the portion of buffer member 40 that overlaps with the outer edge part side of electrode assembly 38. Center portion 38C of electrode assembly 38 is, for example, the geometric center of the outer shape of electrode assembly 38 as viewed in first direction X. The outer edge portion of electrode assembly 38 is, for example, a region of electrode assembly 38 that includes the end portions in second direction Y and the end portions in third direction Z.

In the same manner, at least one of the plurality of second overlapping portions 48b is arranged closer to the center portion 38C side of electrode assembly 38 than the plurality of second spaced-apart portions 48a as viewed in first direction X. As a result, the portion of the buffer member 40 that overlaps with the center portion 38C side of electrode assembly 38 can be more easily deformed than the portion of buffer member 40 that overlaps with the outer edge part side of electrode assembly 38.

Further, in the present exemplary embodiment, as viewed in first direction X, a ratio of an area of stacked part 45 to a unit area of buffer member 40 is smaller on the center part side than on the outer edge part side of buffer member 40. Further, as viewed in first direction X, the ratio of the area of stacked part 45 to the unit area of buffer member 40 is smaller on the center part 13C side than on the outer edge part side of the long side surface of the housing 13. Further, as viewed in first direction X, the ratio of the area of stacked part 45 to the unit area of buffer member 40 is smaller on the center portion 38C side than on the outer edge part side of electrode assembly 38.

By reducing the area of stacked part 45 on the center side of buffer member 40 compared to the area of stacked part 45 on the outer edge part side of buffer member 40, the center side of buffer member 40 can be easily deformed. Further, by reducing the area of stacked part 45 on the center side of the long side surface of housing 13 compared to the area of stacked part 45 on the outer edge part side of the long side surface of housing 13, the portion of buffer member 40 that overlaps with the center side of housing 13 can be more easily deformed. Further, by reducing the area of stacked part 45 on the center side of electrode assembly 38 compared to the area of stacked part 45 on the outer edge part side of electrode assembly 38, the portion of buffer member 40 that overlaps with the center side of electrode assembly 38 can be more easily deformed. The deviation of the distribution of stacked parts 45 in buffer member 40 can be adjusted by the arrangement of first softened portions 46 and second softened portions 48.

The area of first remaining part 47 may be smaller than the area of second remaining part 49 as viewed in first direction X. That is, a ratio of first remaining part 47 to first layer portion 42 may be smaller than a ratio of second remaining part 49 to second layer portion 44. In this case, a larger number of first softened portions 46 can be formed in first layer portion 42. As a result, a contact area between first layer portion 42 and electrical storage device 10 can be reduced. That is, a gap that is brought into contact with electrical storage device 10 can be increased. As a result, first layer portion 42 can easily absorb the expansion of electrical storage device 10.

As materials that can be used for forming first layer portion 42 and second layer portion 44 (that is, first sheet 42a and second sheet 44a), for example, thermosetting elastormors such as natural rubber, synthetic rubber, urethane rubber, silicone rubber, and fluororubber, thermoplastic elastomers such as polystyrene, olefin, polyurethane, polyester and polyamide are named. These materials may be used in a foamed form. Further, a heat insulating material on which a porous material such as silica xerogel is carried is also named. Therefore, buffer member 40 has an insulating property, and can function as a part of separator 12 that insulates electrical storage device 10 from the outside (for example, adjacent electrical storage device 10, end plate 4, constraining member 6, and the like).

### (Method for Manufacturing Buffer Member)

Buffer member 40 can be manufactured as follows, for example. That is, first, first sheet 42a and second sheet 44a are prepared respectively. First softened portions 46 are formed in first sheet 42a in advance, and second softened portions 48 are formed in second sheet 44a in advance. For example, by applying blanking or the like to an elongated sheet that is wound in a roll shape, through holes that penetrate the sheet in a thickness of the sheet are formed. Alternatively, by applying press working or the like to the sheet, recessed parts which are recessed in the thickness of the sheet are formed on the sheet. The sheet in which the through holes or the recessed parts are formed is cut to a predetermined length. As a result, a plurality of first sheets 42a and a plurality of second sheets 44a can be manufactured in large quantities.

Subsequently, first sheet 42a and second sheet 44a are stacked in a state where first softened portion 46 and second softened portion 48 are at least partially displaced from each other. In this exemplary embodiment, first sheet 42a and second sheet 44a have the same size. Then, in a state where the outer edge portion of first sheet 42a and the outer edge portion of second sheet 44a are aligned, that is, in a state where first sheet 42a and second sheet 44a are exactly aligned with each other, first softened portions 46 and second softened portions 48 are positionally displaced from each other. Therefore, by stacking first sheet 42a and second sheet 44a in a state where the outer edge portion of first sheet 42a and the outer edge portion of second sheet 44a are aligned, first softened portions 46 and second softened portions 48 can be displaced from each other.

Buffer member 40 that includes first layer portion 42 and second layer portion 44 can be manufactured in accordance with the above-mentioned steps. According to the method for manufacturing buffer member 40 of the present exemplary embodiment, buffer member 40 can be manufactured only by stacking the sheets to which blanking or press working is applied. Accordingly, buffer member 40 can be manufactured easily and at a low cost.

As has been described above, electrical storage module 1 according to the present exemplary embodiment includes: electrical storage devices 10; and buffer members 40 that are arranged together with electrical storage devices 10 in first direction X and receive a load from electrical storage devices 10 in first direction X. Buffer member 40 has at least first layer portion 42 and second layer portion 44 that are arranged in first direction X. First layer portion 42 has first softened portions 46 each formed of a through hole that penetrates first layer portion 42 in first direction X or recessed parts that are recessed in first direction X. Second layer portion 44 has second softened portions 48 each formed of a through hole that penetrates second layer portion 44 in first direction X or recessed parts that are recessed in first direction X. First softened portion 46 and second softened portion 48 are at least partially displaced from each other as viewed in first direction X.

By forming first softened portions 46 in first layer portion 42, buffer member 40 can be easily deformed in the portions where first softened portions 46 are formed. In the same manner, by forming second softened portions 48 in second softened portion 48, buffer member 40 can be easily deformed in the portions where second softened portions 48 are formed. In other words, by forming first softened portion 46 and second softened portion 48, stacked part 45 that is an area in which first remaining part 47 in first layer portion 42 and second remaining part 49 in second layer portion 44 overlap with each other can be partially reduced in the plane of buffer member 40. As a result, it is possible to provide the portion that is easily deformed and the portion that is less easily deformed in the plane of buffer member 40.

Further, by arranging first softened portions 46 and second softened portions 48 in a state where first softened portion 46 and second softened portion 48 are at least partially displaced from each other, the degree of ease in the deformation of buffer member 40 can be finely set in the plane of buffer member 40. For example, the degree of ease in deformation of buffer member 40 can also be set such that the degree of ease in deformation is gradually increased from one side to the other side in the plane of buffer member 40.

That is, buffer member 40 of the present exemplary embodiment is configured such that the plurality of sheets each has the plurality of through holes or the plurality of recessed parts are stacked, and a load is received by a region (pressure receiving portion) where the solid portions of the respective sheets overlap with each other. As a result, the area that receives a load from electrical storage device 10 can be partially reduced and hence, an apparent compressive elastic modulus can be lowered. Further, with such a configuration, it is possible to form pressure receiving portions each having a fine area that cannot be formed by a single sheet. Further, by adjusting the positions and the areas of the pressure receiving portions, an apparent elastic modulus per macro region can be arbitrarily set. A magnitude of an elastic modulus of buffer member 40 can be changed with gradation. A relatively hard sheet can also be used. Accordingly, compared to a case where a sheet having a low and uniform elastic modulus is used, buffer member 40 can be easily handled in assembling buffer member 40 and electrical storage module 1 and the like. In a case where protrusions are formed on a sheet that forms buffer member 40, a mold for forming becomes necessary. However, the softened portions each formed of a through hole or a recessed part can be formed by a simple method such as blanking of a sheet. Therefore, buffer member 40 can be easily formed.

Therefore, according to the present exemplary embodiment, it is possible to design the arrangement of buffer member 40 such that electrical storage device 10 is positioned by pressing the small expansion portions of electrical storage device 10 by the portions of buffer member 40 that are less easily deformed, and a large load from electrical storage device 10 is absorbed by the portions of buffer member 40 that are easily deformed thus reducing a load applied to constraining members 6. As a result, even when an expansion amount of electrical storage device 10 is increased as the capacity of electrical storage device 10 is increased, the expansion of electrical storage device 10 is more reliably absorbed while ensuring positioning of electrical storage device 10 and hence, a load applied to constraining member 6 can be reduced. Therefore, it is possible to realize both the suppression of breaking of constraining member 6 and the positioning of electrical storage device 10. As a result, it is possible to enhance the reliability of electrical storage module 1.

In general, an expansion amount of electrical storage device 10 is increased along with a lapse of a use period. That is, an expansion amount of electrical storage device 10 changes between an initial stage of life and a terminal stage of life. On the other hand, according to the present exemplary embodiment, a constraining force for constraining battery stack 2 by constraining members 6 is set in accordance with the small expansion of electrical storage device 10 at an initial stage of life. Accordingly, positioning of electrical storage device 10 can be more reliably performed, and at the same time, the large expansion of electrical storage device 10 at a terminal stage of life is absorbed by buffer member 40 and hence, a load applied to constraining members 6 can be reduced. Therefore, even when an expansion amount of electrical storage device 10 changes between an initial stage of life and a terminal stage of life, electrical storage device 10 can be held with an appropriate constraining force in accordance with the expansion amount of electrical storage device 10 at respective stages.

It is possible to avoid the further increase of a strength of constraining member 6 and hence, it is possible to suppress the increase in size, weight, cost, and the like of constraining member 6, and eventually, the increase in size, weight, cost, and the like of electrical storage module 1. It is also possible to prevent the occurrence of a case where a load applied to electrical storage device 10 is increased so that performance of electrical storage device 10 is lowered and the life of electrical storage device 10 is shortened.

Buffer member 40 can be manufactured by only stacking first sheet 42a having first softened portions 46 and second sheet 44a having second softened portions 48 in a state where first softened portion 46 and second softened portion 48 are at least partially displaced from each other. Therefore, buffer member 40 can be manufactured easily and at a low cost. The adjustment of the degree of ease in deformation in the plane can be easily realized. In the plane of buffer member 40, the pressure receiving portions each having a fine area and receiving a force from electrical storage device 10 can be easily formed.

In the present exemplary embodiment, first layer portion 42 has the plurality of first softened portions 46, and the density of first layer portion 42 is smaller on the center part side of first layer portion 42 than on the outer edge part side of first layer portion 42 as viewed in first direction X. Second layer portion 44 has the plurality of second softened portions 48, and the density of second layer portion 44 is smaller on the center part side of second layer portion 44 than on the outer edge part side of second layer portion 44 as viewed in first direction X. As viewed in first direction X, a ratio of an area of stacked part 45 to the unit area of buffer member 40 is smaller on the center part side of buffer member 40 than on the outer edge part side of buffer member 40. As a result, it is possible to obtain buffer member 40 where the center part side is easily deformed and the outer edge part side is less easily deformed. Therefore, it is possible to more reliably realize the suppression of breaking of constraining member 6 and the positioning of electrical storage device 10.

Some first softened portions 46 (first spaced-apart portions 46a) are arranged such that the entirety of first softened portion 46 is displaced with respect to second softened portion 48 as viewed in first direction X, and other first softened portions 46 (first overlapping portions 46b) are arranged such that first softened portion 46 is partially displaced from second softened portion 48 as viewed in first direction X. In the same manner, some second softened portions 48 (second spaced-apart portions 48a) are arranged such that second softened portion 48 is totally displaced from first softened portion 46 as viewed in first direction X, and other second softened portions 48 (second overlapping portions 48b) are arranged such that second softened portion 48 is partially displaced from first softened portion 46 as viewed in first direction X. As a result, the degree of ease in deformation of buffer member 40 can be adjusted more finely in accordance with places and hence, it is possible to allow buffer member 40 to be deformed in conformity with the expansion of electrical storage device 10 with higher accuracy. Therefore, both the absorption of the expansion and the positioning of electrical storage device 10 can be realized.

At least one of first overlapping portions 46b is arranged closer to the center part side of buffer member 40 than first spaced-apart portion 46a as viewed in first direction X. In the same manner, at least one of second overlapping portions 48b is arranged closer to the center part side of buffer member 40 than second spaced-apart portion 48a as viewed in first direction X. As a result, the center part side of buffer member 40 can be more easily deformed than the outer edge part side of buffer member 40.

Further, at least one of first overlapping portions 46b is arranged closer to the center part 13C side of the long side surface of housing 13 than first spaced-apart portion 46a as viewed in first direction X. In the same manner, at least one of second overlapping portions 48b is arranged closer to the center part 13C side of the long side surface of housing 13 than second spaced-apart portion 48a as viewed in first direction X. Further, as viewed in first direction X, the ratio of the area of stacked part 45 to the unit area of buffer member 40 is smaller on the center part 13C side than on the outer edge part side of the long side surface of the housing 13. As a result, the portion of buffer member 40 that overlaps with the center part 13C side of the long side surface of housing 13 can be more easily deformed than the portion of buffer member 40 that overlaps with the outer edge part side of the long side surface of the housing 13.

At least one of first overlapping portions 46b is arranged closer to the center portion 38C side of electrode assembly 38 than first spaced-apart portion 46a as viewed in first direction X. In the same manner, at least one of second overlapping portions 48b is arranged closer to the center portion 38C side of electrode assembly 38 than second spaced-apart portion 48a as viewed in first direction X. Further, as viewed in first direction X, the ratio of the area of stacked part 45 to the unit area of buffer member 40 is smaller on the center portion 38C side than on the outer edge part side of electrode assembly 38. As a result, in buffer member 40, the portion of buffer member 40 that overlaps with the center portion 38C side of electrode assembly 38 can be more easily deformed than the portion of buffer member 40 that overlaps with the outer edge part side of electrode assembly 38.

The exemplary embodiments of the present disclosure have been described in detail heretofore. The above-described exemplary embodiment is merely a specific example for implementing the present disclosure. The contents of the exemplary embodiments do not limit the technical scope of the present disclosure, and many design changes such as changes, additions, and deletions of constituent elements can be made without departing from the spirit of the invention defined in the claims. Any new exemplary embodiment to which a design change has been made has an advantageous effect of each of the combined exemplary embodiments and modifications. In the above-described exemplary embodiment, with respect to the contents where such design changes can be made, the contents are emphasized with expressions such as “of the present exemplary embodiment” and “in the present exemplary embodiment”. However, design changes are allowed even with respect to the contents that are not described with such expressions. Further, any combination of constituent elements included in each exemplary embodiment is also effective as an aspect of the present disclosure. Hatching applied to the cross section in the drawing does not limit the material of the object to which the hatching is applied.

### (First Modification)

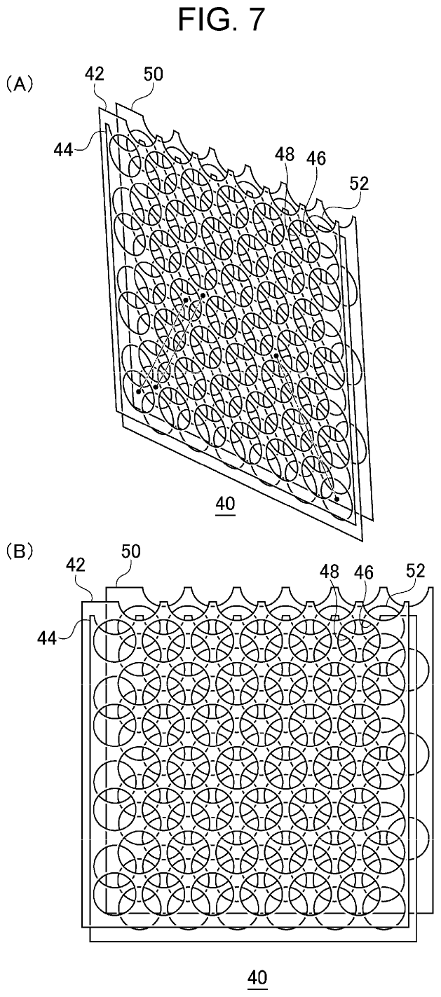

FIG. 7(A) is a perspective view of buffer member 40 according to a first modification. FIG. 7(B) is a front view of buffer member 40. Buffer member 40 according to the exemplary embodiment has the two-layer structure formed of first layer portion 42 and second layer portion 44. However, the number of layers is not particularly limited. For example, buffer member 40 according to this modification has a three-layer structure formed of first layer portion 42, second layer portion 44, and third layer portion 50. First layer portion 42, second layer portion 44, and third layer portion 50 are arranged in this order in first direction X. Third layer portion 50 has third softened portions 52 each formed of a through hole that penetrates third layer portion 50 in first direction X or recessed parts that are recessed in first direction X. FIG. 7(A) and FIG. 7(B) show third softened portions 52 formed of through holes. Respective softened portions are uniformly arranged at an equal interval on substantially the entirety of a sheet which forms each layer portion.

In buffer member 40 according to the exemplary embodiment, the positions of first softened portions 46 and the positions of second softened portion 48 are displaced from each other in a state where first layer portion 42 and second layer portion 44 are exactly aligned with each other. On the other hand, in buffer member 40 according to the first modification, first layer portion 42, second layer portion 44 and third layer portion 50 have the same shape including the arrangement of the respective softened portions. By arranging first layer portion 42 and second layer portion 44 such that outer edge portions of first layer portion 42 and outer edge portions of second layer portion 44 are displaced from each other, first softened portions 46 and second softened portions 48 are displaced from each other. Further, by arranging second layer portion 44 and third layer portion 50 such that outer edge portions of second layer portion 44 and outer edge portions of third layer portion 50 are displaced from each other, second softened portions 48 and third softened portions 52 are displaced from each other.

Buffer members 40 according to this modification can also acquire substantially the same advantageous effects as the exemplary embodiment. Further, in this modification, first layer portion 42 to third softened portion 52 have the same shape and hence, the steps of manufacturing buffer member 40 can be further simplified. Further, first layer portion 42 and third layer portion are also arranged so as to be displaced from each other. Accordingly, first softened portions 46 and third softened portions 52 are displaced from each other. With such a configuration, the degree of ease in deformation of buffer member 40 can be adjusted more finely.

### (Second Modification)

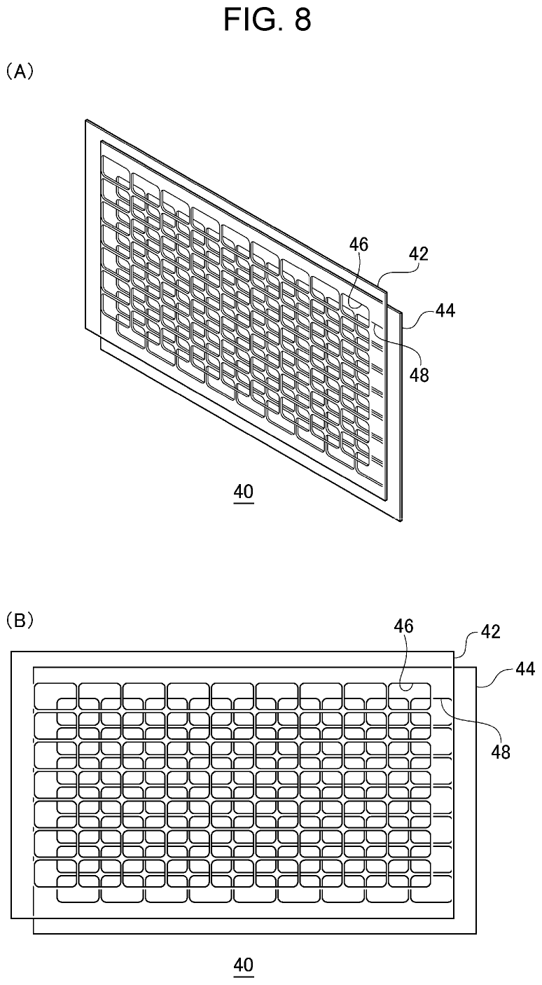

FIG. 8(A) is a perspective view of buffer member 40 according to a second modification. FIG. 8(B) is a front view of buffer member 40. First softened portions 46 and second softened portions 48 that buffer member 40 according to the exemplary embodiment has are formed in a circular shape as viewed in first direction X. However, the shapes of respective softened portions are not particularly limited. For example, first softened portions 46 and second softened portions 48 that buffer member 40 according to the present modification has are formed in a substantially rectangular shape as viewed in first direction X. Further, first layer portion 42 and second layer portion 44 may have a polygonal shape such as a hexagonal shape.

### (Third Modification)

Buffer member 40 may be provided to all combinations each formed of two electrical storage devices 10 arranged adjacent to each other, or may be provided to some combinations. Further, buffer member 40 may be provided between electrical storage device 10 and end plate 4 in addition to being provided between two electrical storage devices 10. Further, buffer member 40 may be provided only between electrical storage device 10 and end plate 4.

### (Fourth Modification)

The number of electrical storage devices 10 that electrical storage module 1 includes is not particularly limited, and electrical storage module 1 may have at least one electrical storage device 10. The structures of respective portions of electrical storage module 1 including the structure of end plate 4 and the structure of constraining member 6 are not particularly limited.

### (Fifth Modification)

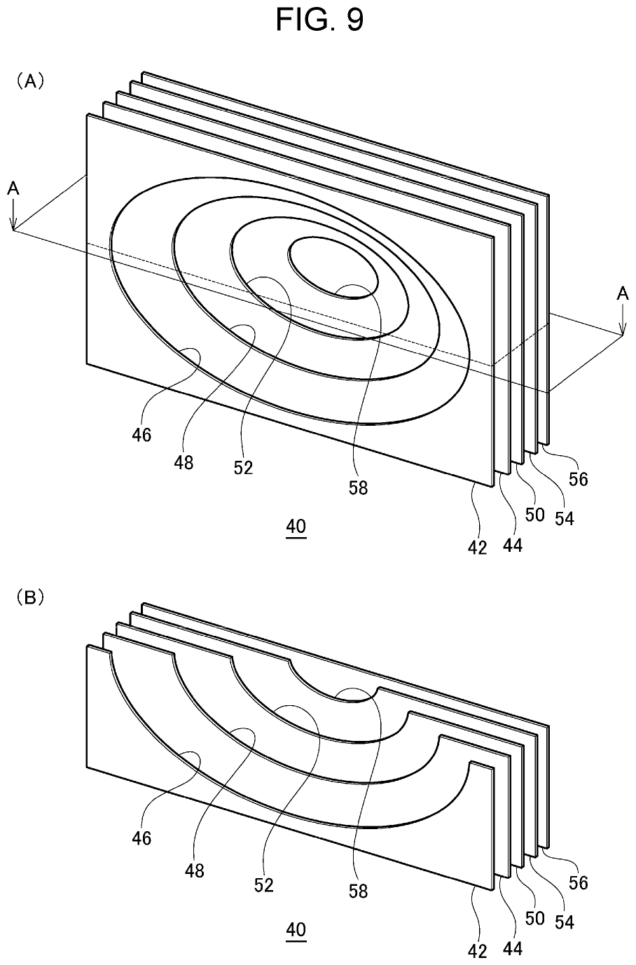

FIG. 9(A) is a perspective view of buffer member 40 according to a fifth modification. FIG. 9(B) is a cross-sectional perspective view taken along line A-A in FIG. 9(A). Buffer member 40 according to this modification includes, as an example, a five-layer structure formed of first layer portion 42, second layer portion 44, third layer portion 50, fourth layer portion 54, and fifth layer portion 56. First layer portion 42, second layer portion 44, third layer portion 50, fourth layer portion 54 and fifth layer portion 56 are arranged in this order in first direction X. Third layer portion 50 has third softened portion 52, and fourth layer portion 54 has fourth softened portion 58. First softened portion 46 to fourth softened portion 58 are each formed of a through hole. Fifth layer portion 56 does not have a softened portion.

The softened portions of respective layer portions are arranged concentrically. Further, opening areas of first softened portion 46 to fourth softened portion 58 are gradually decreased in this order. Therefore, buffer member 40 includes a recessed part that has an inner side surface that curves so as to make the recessed part wider as approaching a first layer portion 42 side. When electrical storage device 10 arranged on first layer portion 42 side expands, the expansion portion of electrical storage device 10 can be accommodated in the recessed part.

### REFERENCE SIGNS IN THE DRAWINGS

1 electrical storage module
10 electrical storage device
13 housing
38 electrode assembly
40 buffer member
42 first layer portion
42a first sheet
44 second layer portion
44a second sheet
46 first softened portion
48 second softened portion

1. An electrical storage module comprising:
at least one electrical storage device; and
a buffer member that is arranged together with the at least one electrical storage device in a first direction and is configured to receive a load from a corresponding one of the at least one electrical storage device in the first direction,
Wherein
the buffer member includes at least a first layer portion and a second layer portion arranged in the first direction,
the first layer portion includes a first softened portion, the first softened portion being a through hole that penetrates the first layer portion in the first direction or a recessed part that is recessed in the first direction,
the second layer portion includes a second softened portion, the second softened portion being a through hole that penetrates the second layer portion in the first direction or a recessed part that is recessed in the first direction, and
the first softened portion and the second softened portion are at least partially displaced from each other as viewed in the first direction.

2. The electrical storage module according to claim 1, wherein
the first layer portion includes a first remaining part that is a part excluding the first softened portion,
the second layer portion includes a second remaining part that is a part excluding the second softened portion, and
the buffer member includes a stacked part in which the first remaining part and the second remaining part overlap with each other.

3. The electrical storage module according to claim 2, wherein as viewed in the first direction, a ratio of an area of the stacked part to a unit area of the buffer member is smaller on a center part side of the buffer member than on an outer edge part side of the buffer member.

4. The electrical storage module according to claim 3, wherein
each of the at least one electrical storage device includes a housing, a pair of output terminals arranged on a first surface of the housing, and an electrode assembly housed in the housing,
the housing includes a side surface that extends in a direction intersecting with a first direction, and
as viewed in the first direction, the ratio of an area of the stacked part to a unit area of the buffer member is smaller on a center part side than on an outer edge part side of the side surface.

5. The electrical storage module according to claim 3, wherein
each of the at least one electrical storage device includes a housing, a pair of output terminals arranged on a first surface of the housing, and an electrode assembly housed in the housing,
the electrode assembly includes a positive electrode and a negative electrode arranged in the first direction, and
as viewed in the first direction, a ratio of an area of the stacked part to a unit area of the buffer member is smaller on a center part side of the electrode assembly than on an outer edge part side of the electrode assembly.

6. The electrical storage module according to claim 2, wherein as viewed in a first direction, an area of the first remaining part is smaller than an area of the second remaining part.

7. The electrical storage module according to claim 1, wherein density of the first layer portion is smaller on a center part side of the first layer portion than on an outer edge part side of the first layer portion as viewed in a first direction.

8. The electrical storage module according to claim 7, wherein the first layer portion includes a plurality of first spaced-apart portions that are totally displaced from the second softened portion as viewed in a first direction, and a plurality of first overlapping portions that are partially displaced from the second softened portion as viewed in a first direction.

9. The electrical storage module according to claim 8, wherein at least one of the plurality of first overlapping portions is arranged closer to the center part side of the buffer member than the plurality of first spaced-apart portions as viewed in the first direction.

10. The electrical storage module according to claim 8, wherein
each of the at least one electrical storage device includes a housing, a pair of output terminals arranged on a first surface of the housing, and an electrode assembly housed in the housing,
the housing includes a side surface that extends in a direction intersecting with a first direction, and
at least one of the plurality of first overlapping portions is arranged closer to the center part side of the side surface than the plurality of first spaced-apart portions as viewed in the first direction.

11. The electrical storage module according to claim 8, wherein
each of the at least one electrical storage device includes a housing, a pair of output terminals arranged on a first surface of the housing, and an electrode assembly housed in the housing,
the electrode assembly includes a positive electrode and a negative electrode arranged in the first direction, and
at least one of the plurality of first overlapping portions is arranged closer to the center part side of the electrode assembly than the plurality of first spaced-apart portions as viewed in the first direction.

12. The electrical storage module according to claim 7, wherein a density of the second layer portion is smaller on a center part side than on an outer edge part side of the second layer portion as viewed in the first direction.

13. The electrical storage module according to claim 12, wherein the second layer portion includes:
a plurality of second spaced-apart portions that are totally displaced from the first softened portion as viewed in first direction; and
a plurality of second overlapping portions that are partially displaced from the first softened portion as viewed in the first direction.

14. The electrical storage module according to claim 13, wherein at least one of the plurality of second overlapping portions is arranged closer to the center part side of the buffer member than the plurality of second spaced-apart portions as viewed in a first direction.

15. The electrical storage module according to claim 13, wherein
each of the at least one electrical storage device includes a housing, a pair of output terminals arranged on a first surface of the housing, and an electrode assembly housed in the housing,
the housing includes a side surface that extends in a direction intersecting with the first direction, and
at least one of the plurality of second overlapping portions is arranged closer to the center part side of the side surface than the plurality of second spaced-apart portions as viewed in the first direction.

16. The electrical storage module according to claim 13, wherein
each of the at least one electrical storage device includes a housing, a pair of output terminals arranged on a first surface of the housing, and an electrode assembly housed in the housing,
the electrode assembly includes a positive electrode and a negative electrode arranged in the first direction, and
at least one of the plurality of second overlapping portions is arranged closer to the center part side of the electrode assembly than the plurality of second spaced-apart portions as viewed in the first direction.

17. A buffer member that is arranged in a first direction together with at least one electrical storage device and receives a load from a corresponding one of the at least one electrical storage device in the first direction,
the buffer member comprising at least a first layer portion and a second layer portion arranged in the first direction, wherein
the first layer portion includes a first softened portion, the first softened portion being a through hole that penetrates the first layer portion in the first direction or a recessed part that is recessed in the first direction,
the second layer portion includes a second softened portion, the second softened portion being a through hole that penetrates the second layer portion in the first direction or a recessed part that is recessed in the first direction, and
the first softened portion and the second softened portion are at least partially displaced from each other as viewed in the first direction.

18. A method for manufacturing a buffer member that is arranged in a first direction together with at least one electrical storage device and receives a load from the at least one electrical storage device in the first direction, the method comprising stacking in a state where a first softened portion and a second softened portion are partially displaced from each other, a first sheet including the first softened portion including a through hole that penetrates the first sheet in a thickness or a recessed part that is recessed in a thickness and a second sheet including the second softened portion including a through hole that penetrates the second sheet in the thickness or a recessed part that is recessed in a thickness.
